(19) United States
(12) Patent Application Publication
(10) Pub. No.: US 2024/0229991 A1
(43) Pub. Date: Jul. 11, 2024

(54) NUT TYPE ROTATABLE FLANGE STRUCTURE AND COMBINATION TOOL

(71) Applicant: Southwestern Institute of Physics, Chengdu (CN)

(72) Inventors: Yong LI, Chengdu (CN); Fangzheng ZHA, Chengdu (CN); Jun LI, Chengdu (CN)

(21) Appl. No.: 18/614,910

(22) Filed: Mar. 25, 2024

Related U.S. Application Data
(63) Continuation of application No. PCT/CN2021/131096, filed on Nov. 17, 2021.

(30) Foreign Application Priority Data
Oct. 28, 2021 (CN) 202111265125.3

(51) Int. Cl. F16L 23/036; B25B 13/50; F16L 23/032

(52) U.S. Cl. CPC F16L 23/036; B25B 13/50; F16L 23/032

(57) ABSTRACT

Provided are a nut type rotatable flange structure and a combination tool. Flanges of a first neck flange and a second neck flange are both arranged in a nut type rotatable flange collar, one of the flanges is secured by using a thread, and the other flange is secured by using jack bolts, so that the flanges of the first neck flange and the second neck flange are hermetically and stably fixed, instead of a method of aligning bolt holes in a flange with bolt holes in another flange and then screwing in bolts to achieve connection. In general, the nut type rotatable flange structure and the combination tool can achieve a hermetical connection between the flanges, with no need to use a conventional method of aligning a plurality of bolt holes to a plurality of bolt holes in flanges, which requires less mounting accuracy and improves operation convenience.

### CROSS-REFERENCE TO RELATED APPLICATIONS

The present application is a continuation of International Patent Application No. PCT/CN2021/131096, filed Nov. 17, 2021, which claims the benefit under 35 U.S.C. § 119 of Chinese application Ser. No. 202111265125.3, filed Oct. 28, 2021, the disclosures of each of which are incorporated herein by reference in their entirety.

### TECHNICAL FIELD

The present invention relates to the technical field of flange connection, and in particular, to a nut type rotatable flange structure and a combination tool.

### BACKGROUND

Currently, pipelines are generally connected by using flanges formed at ends of the pipelines. Flanges of two pipelines are aligned together, and after the alignment, bolt holes of two flanges need to be aligned together for passing through bolts and nuts, thus completing fixed connection between the flanges of the two pipelines. This conventional flanges connection method requires alignment accuracy between bolt holes in flanges to achieve more stable bolted connection. Once machining accuracy between the bolt holes in flanges decreases or the alignment accuracy there between is not high, unstable connection between pipelines is likely to occur.

In view of this, the present application is provided.

### SUMMARY

An objective of the present invention is to provide a nut type rotatable flange structure and a combination tool. The flange structure and the combination tool replace a conventional method of aligning bolt holes of the two flanges, that is, two flanges can be stably connected to each other while stable sealing is ensured.

Embodiments of the present invention are implemented as follows.

First, a nut type rotatable flange structure includes a nut type rotatable flange collar, a first neck flange, a second neck flange, and jack bolts. A connecting thread is machined on an inner surface from one end of the nut type rotatable flange collar, an annular protuberances is formed on an inner surface of the other end of the nut type rotatable flange collar, and screw through holes are machined in the annular protuberances in an axial direction of the nut type rotatable flange collar; a neck of the first neck flange passes through an inner hole of the annular protuberances, an outer surface of the neck fits with the inner hole of the annular protuberances, a flange portion of the first neck flange is placed in an inner hole of the nut type rotatable flange collar, and an outer surface of the flange portion fits with the inner hole of the nut type rotatable flange collar; an external thread is machined on an outer surface of a flange portion of the second neck flange, the external thread of the flange portion fits with the connecting thread of the nut type rotatable flange collar, and a sealing gasket is placed between the flange portion of the second neck flange and the flange portion of the first neck flange; and the jack bolts are driven in the screw through holes in the annular protuberances, and the screw ends of the jack bolts can act on the flange portion of the first neck flange, so that the flange portion of the first neck flange, the flange portion of the second neck flange and the sealing gasket are hermetically connected to each other.

In an optional implementation, the nut type rotatable flange structure further includes a hard washer, where the hard washer is sleeved on the neck of the first neck flange, and the hard washer is abutted against between the screw ends of the jack bolts and the flange portion of the first neck flange.

In an optional implementation, the inner hole of the nut type rotatable flange collar includes an internal thread section, a cutting tool escape section and a protuberances fitting section which are sequentially connected; and the internal thread section is configured to form the connecting thread, the cutting tool escape section is for accommodating the flange portion of the first neck flange and the hard washer, a washer fitting section is configured to fit with the hard washer, and the protuberances fitting section is configured to form the annular protuberances.

In an optional implementation, a solid lubricant coating is arranged on an end surface of at least one side of the hard washer.

In an optional implementation, a thread rotation direction of the connecting thread is opposite to a thread rotation direction of the screw through hole, a minimum clearance of fit between the screw through hole and the jack bolt is a first clearance, a minimum clearance of fit between the connecting thread and the external thread of the flange portion of the second neck flange is a second clearance, and the size of the first clearance is greater than the size of the second clearance; and
the solid lubricant coating can generate elastic deformation in an axial direction of the hard washer, and when the solid lubricant coating is arranged on an end surface of one side of the hard washer, a maximum deformation quantity of the elastic deformation generated by the solid lubricant coating on the one side is not less than a sum of the sizes of the first clearance and the second clearance; or when each of end surfaces of two sides of the hard washer is arranged with the solid lubricant coating, a maximum total deformation quantity of the elastic deformation generated by the solid lubricant coatings on the two sides is not less than the sum of the sizes of the first clearance and the second clearance.

In an optional implementation, positioning grooves are formed in one side of the flange portion of the first neck flange and one side of the flange portion of the second neck flange which are moving close to each other, a volume for accommodating the sealing gasket is formed between the two positioning grooves, and the sealing gasket is attached to the positioning groove in either side by using a connecting member.

In an optional implementation, a plurality of screw through holes are provided, and the plurality of screw through holes are evenly distributed in the annular protuberances around the axis of the nut type rotatable flange collar in a circumferential direction; a number of the jack bolts is equal to a number of the screw through holes, and each jack bolts be screwed into each screw through hole.

In an optional implementation, a boss portion which can interact with a wrench is formed on an outer surface of a neck of the second neck flange; and/or a boss portion which can interact with a wrench is formed on an outer surface of the nut type rotatable flange collar.

Second, a nut type rotatable flange combination tool includes an operating spanner and the above-mentioned nut type rotatable flange structure, where the nut type rotatable flange structure is provided with a plurality of screw through holes, and the plurality of screw through holes are evenly distributed in an annular protuberances around the axis of the nut type rotatable flange collar in a circumferential direction; a number of jack bolts is equal to a number of the screw through holes, and each jack bolt fit with the threads of each screw through hole; the operating spanner includes a handle and a positioning portion which are connected to each other, and the positioning portion can be fixed by at least two jack bolts; and a boss portion which can interact with a wrench is formed on an outer surface of a neck of the second neck flange.

In an optional implementation, at least two positioning holes are machined in the positioning portion, and the at least two positioning holes can be correspondingly sleeved with a same number of jack bolts simultaneously.

The embodiments of the present invention have the following beneficial effects:

In the nut type rotatable flange structure according to the embodiments of the present invention, the first neck flange and the second neck flange are arranged in the nut type rotatable flange collar, and the two neck flanges are aligned precisely and constrained in the inner hole of the nut type rotatable flange collar. Therefore, on the one hand, a constraint space be formed, and the flanges on two sides can be aligned precisely, which replaces a conventional method of aligning bolt holes; and on the other hand, operation convenience is greatly improved, and the flanges on the two sides only need to be placed in the inner hole of the nut type rotatable collar, without inserting a plurality of bolts through the precisely aligned bolt holes of two flanges. In addition, by setting of the jack bolts in the annular protuberances of the nut type rotatable flange collar, the neck flanges on the two sides can abut against each other, thus achieving a hermetical and stable connection.

In addition, in the nut type rotatable flange combination tool according to the embodiments of the present invention, based on the above-mentioned nut type rotatable flange structure, a force for fastening the nut type rotatable flange collar can be applied on it by spinning the handle, thereby benefiting the connection between the flanges on the two sides and other structures, benefiting the connection with other structures based on the hermetical connection between the flanges, and achieving more convenient operation.

Generally, the nut type rotatable flange structure and the combination tool according to the embodiments of the present invention can achieve a hermetical connection between the flanges, with no need to use the conventional method of connecting a plurality of bolt holes to a plurality of bolt holes in flanges, which requires less mounting accuracy and be more convenient, and can be more convenient during dismantling and assembling while ensuring connection stability between the flanges.

### BRIEF DESCRIPTION OF DRAWINGS

To more clearly describe the technical solutions of the embodiments of the present invention, the accompanying drawings required in the embodiments are described briefly below. It should be understood that the following accompanying drawings illustrate only some embodiments of the present invention and therefore should not be construed as a limitation on the scope thereof. For a person of ordinary skill in the art, other relevant accompanying drawings can also be obtained from these accompanying drawings without any creative effort.

FIG. 1 is a schematic front view of a nut type rotatable flange structure according to an embodiment of the present invention;

FIG. 2 is a schematic left view of a nut type rotatable flange structure according to an embodiment of the present invention;

FIG. 3 is a sectional view of a nut type rotatable flange structure according to an embodiment of the present invention taken along line A-A;

FIG. 4 is a schematic structural diagram of a nut type rotatable flange collar and a second neck flange according to an embodiment of the present invention; and

FIG. 5 is a schematic structural diagram of a nut type rotatable flange combination tool according to an embodiment of the present invention.

### DESCRIPTION OF EMBODIMENTS

To make the objectives, technical solutions and advantages of the embodiments of the present invention clearer, the technical solutions in the embodiments of the present invention will be described clearly and comprehensively below with reference to the accompanying drawings in the embodiments of the present invention. Obviously, the embodiments described are some of, rather than all of, the embodiments of the present invention. Generally, assemblies of the embodiments of the present invention described and illustrated in the accompanying drawings herein may be arranged and designed in a variety of different configurations.

Therefore, the following detailed description of the embodiments of the present invention provided in the accompanying drawings is not intended to limit the scope of the present invention as claimed, but is merely representative of the selected embodiments of the present invention. All other embodiments obtained by a person of ordinary skill in the art based on the embodiments of the present invention without creative efforts shall fall within the protection scope of the present invention.

It should be noted that similar reference numerals and letters indicate similar items in the following accompanying drawings. Therefore, once an item is defined in one accompanying drawing, the item does not need to be further defined and explained in subsequent accompanying drawings.

In the description of the present invention, it should be noted that an orientation or positional relationship indicated by the term “center”, “upper”, “lower”, “left”, “right”, “vertical”, “horizontal”, “inner”, “outer”, or the like is based on the orientation or positional relationship shown in the accompanying drawings, or the orientation or positional relationship of products of the present invention that are usually placed in use, which is only for convenience of describing the present invention and simplifying the description, rather than indicating or implying that the device or element referred to must have a particular orientation and be constructed and operated in a particular orientation, and therefore should not be construed as limiting the present invention. In addition, the terms “first”, “second”, “third”, etc. are merely used for distinct description, and shall not be construed as indicating or implying relative importance.

In the description of the present invention, it should also be noted that, unless otherwise explicitly specified and limited, the terms “arrange”, “mount”, “connected”, and “connect” should be broadly understood. For example, the term may be a fixed connection, a detachable connection or an integral connection; and may be a direct connection, an indirect connection by using an intermediate medium, or internal communication between two elements. For a person of ordinary skill in the art, the specific meanings of the terms mentioned above in the present invention may be construed according to specific circumstances.

### Embodiment 1

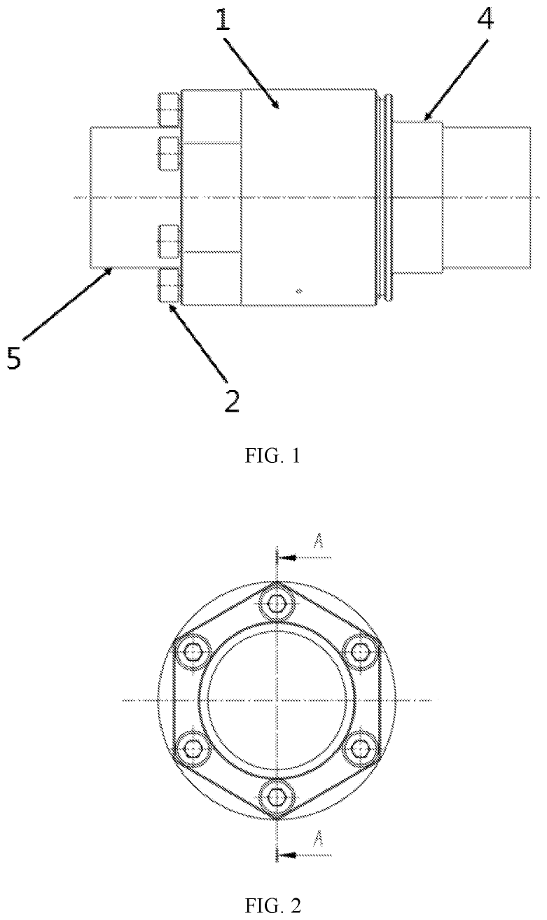

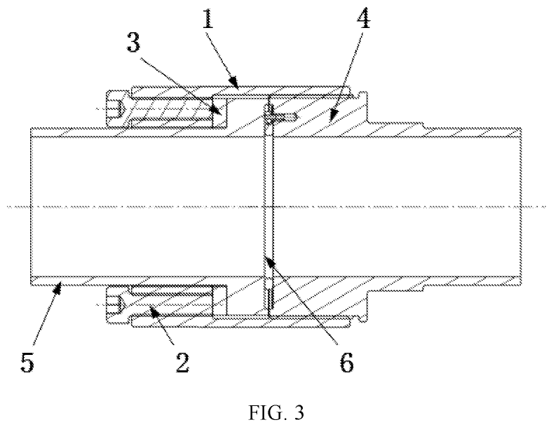

Referring to FIG. 1 to FIG. 3, a nut type rotatable flange structure provided in this embodiment mainly includes a nut type rotatable flange collar 1, a first neck flange 5, a second neck flange 4, and jack bolts 2, where the first neck flange 5 and the second neck flange 4 mainly refer to flanges connected to pipelines, and certainly, may refer to flanges connected to other components or platforms in other applicable scenes. The present application aims to form a structure that replaces the connection between conventional flanges, and components connected but not belong to the flanges will not be described in detail.

In this embodiment, a connecting thread is machined on an inner surface of one end of the nut type rotatable flange collar 1, an annular protuberances 16 is formed on an inner surface of the other end of the nut type rotatable flange collar, and screw through holes 15 are machined in the annular protuberances 16 in an axial direction of the nut type rotatable flange collar 1. This means that the annular protuberances 16 is formed in an internal space of the nut type rotatable flange collar 1, and screw through holes 15 are drilled through end surfaces of two sides of the annular protuberances 16, and an axial direction of each screw through hole 15 is the same as the axial direction of the nut type rotatable flange collar 1. By using the above technical solution, a main part of the nut type rotatable flange collar 1 is formed, and the nut type rotatable flange collar 1 is used as a constriction part to constrain a position or space formed by the connection of the first neck flange 5 and the second neck flange 4, instead of a conventional method in which the connection between flanges needs holes alignment with an extra platform or manual assisted positioning.

A neck of the first neck flange 5 passes through an inner hole of the annular protuberances 16, and an outer surface of the neck matches with the inner hole of the annular protuberances 16. The matching herein may refer to the hole-axis-type fixed fit, such as interference fit, transition fit or clearance fit (mainly referring to clearance fit in general scenes), or may refer to hole-axis-type mutual running fit, that is, a certain clearance capable of rotation is provided, and rotation is performed in different applicable scenes to determine whether the first neck flange 5 needs to rotate relative to the nut type rotatable flange collar 1. A flange portion of the first neck flange 5 is placed in the inner hole of the nut type rotatable flange collar 1, and an outer surface of the flange portion matches with the inner hole of the nut type rotatable flange collar 1. The matching herein is the same as the above-mentioned type, that is, whether the first neck flange 5 needs to be rotated relative to the nut type rotatable flange collar 1 can be determined according to requirements of an applicable scene, and it can be concluded that the first neck flange 5 and the nut type rotatable flange collar 1 are mainly coaxially arranged herein.

Similarly, the second neck flange 4 is mainly arranged coaxially with the nut type rotatable flange collar 1. Specifically, an external thread is machined on an outer surface of a flange portion 42 of the second neck flange 4, the flange portion 42 fits with the connecting thread of the nut type rotatable flange collar 1 by using the external thread of the flange portion, which means that the second neck flange 4 and the nut type rotatable flange collar 1 are detachable fixed by using threaded connection, and the both connecting portions are the flange portion 42 of the second neck flange 4 and the connecting thread at the end of the inner hole of the nut type rotatable flange collar 1. A relative position relationship between the first neck flange 5 and the second neck flange 4 is determined by the arrangement of the nut type rotatable flange collar 1. In this case, the sealing ability between the two flanges needs to be ensured. A sealing gasket 6 is arranged between the flange portion 42 of the second neck flange 4 and the flange portion of the first neck flange 5, which means that the sealing gasket 6 is arranged between end surfaces of the flanges on two sides that are in contact with each other, so as to ensure the sealing ability of the joint. It should be noted that the sealing gasket 6 maybe a metal sealing ring or a plastic sealing ring, or may be a component made of a viscous material, or may be a sealing medium in some special application scenes, such as a sealing fluid (gas or liquid) medium, with that between the end surfaces of the flange portion 42 of the second neck flange 4 and the flange portion of the first neck flange 5 which squeeze each other to form a hermetical connection.

To achieve mutual squeezing and approaching between the first neck flange 5 and the second neck flange 4 so as to ensure the sealing ability there between, the jack bolts 2 fit with threads of the screw through holes 15 in the annular protuberances 16, which means that the jack bolts 2 are in threaded connection with the screw through holes 15, and screw ends of the jack bolts 2 can act on the flange portion of the first neck flange 5, so that the flange portion of the first neck flange 5, the flange portion 42 of the second neck flange 4 and the sealing gasket 6 are hermetically connected to each other. By means of the above technical solution, the jack bolts 2 only need to be screwed in, so that the jack bolts act on the flange portion of the first neck flange 5 to push the entire first neck flange 5 to move and approach the second neck flange 4, so as to squeeze the sealing gasket 6 to a certain extent between the first neck flange 5 and the second neck flange 4, and thus the sealing gasket 6 meets requirements for a preload, thereby ensuring the sealing ability of the connection between the three. By using of the jack bolts 2 without a conventional operation of aligning flange holes, and by screwing the jack bolts 2, a strong jacking force will be generated. The jacking force and a reaction force on the nut type rotatable flange collar 1 generate a strong clamping force on the flanges, so that the sealing gasket 6 is pre-tightened to achieve the sealing effect. In addition, the jack bolts 2 with a small friction diameter, can achieve a huge jacking force with a relatively small torque, thereby facilitating actual operation.

By using the main technical solution of the nut type rotatable flange structure in this embodiment, it can be concluded that, the solution is different from a conventional method of aligning one circle of bolt holes with another circle of bolt holes of two flanges and then sequentially screwing in connecting bolts (with nuts), and the conventional method needs repeatedly precise alignment of the bolt holes in flanges, which is completed by a special supporting auxiliary tool for fitting while adjusting, or relies on pure manual positioning on two sides, thereby being relatively troublesome and complicated to some extent. In combination with the above-mentioned rotatable flange structure according to the present application, only the first neck flange 5 and the second neck flange 4 (with the sealing gasket 6) need to be sent or screwed into the nut type rotatable flange collar 1, and finally the jack bolts 2 are screwed in from a single side, so that the flanges on two sides can be stably and hermetically connected without a complicated hole position alignment operation on the two sides, and an assembly operation can be completed directly by one person after machining according to accuracy requirements, thus avoiding the shortcomings of needing two persons or relying heavily on a special tool in the traditional method.

Generally, the nut type rotatable flange structure in this embodiment takes the nut type rotatable flange collar 1 as the initial limiting component. After the nut type rotatable flange collar 1 is positioned, the first neck flange 5, the sealing gasket 6 and the second neck flange 4 can be sequentially mounted, and finally the jack bolts 2 are screwed in. This not only is suitable for the assembling operation by one person, but also is convenient and fast for the whole assembling, can ensure the stability and sealing ability of the connection, can replace the conventional method of connecting flanges, and there will be a wide application prospect.

To alleviate hard damage between the screw end (end be screwed in) of the jack bolts 2 and the flange portion of the first neck flange 5, the nut type rotatable flange structure further includes a hard washer 3, where the hard washer 3 is sleeved on the neck of the first neck flange 5, and the hard washer 3 is abutted against between the screw end of the jack bolts 2 and the flange portion of the first neck flange 5. That is, the hard washer 3 acts as a load transmission part between the jack bolts 2 and the first neck flange 5, especially the screw end of the jack bolts 2 directly acts on the hard washer 3, and the hard washer 3 transmits the corresponding jacking force to the flange portion of the first neck flange 5 as a whole, so as to increase the stressed area evenly, thereby alleviating damage on the flange portion of the first neck flange 5, and later maintenance can be performed by replacing the hard washer 3, thus ensuring the service life of the first neck flange 5. It should be noted that, for a person skilled in the art, the hard washer 3 usually refers to a steel structure with heat treatment hardness greater than HRC44, so it is only needed to determine a model of the hard washer according to applicable scenes and requirements, and details are not repeated herein.

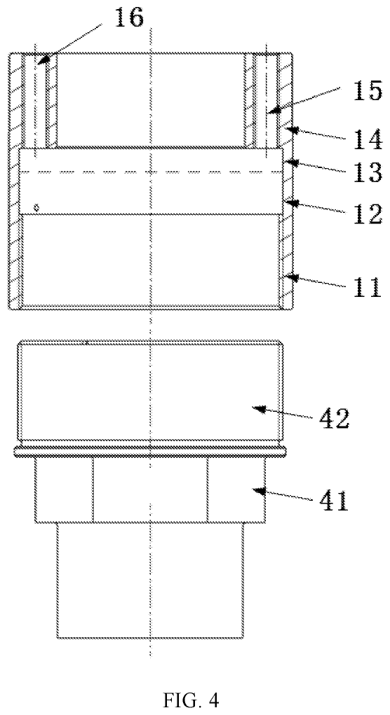

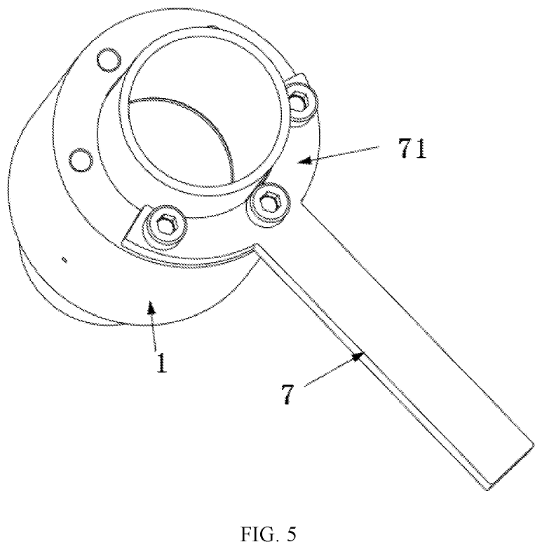

Referring to FIG. 4, to ensure effective interaction between the jack bolts 2, the hard washer 3, the first neck flange 5, and the second neck flange 4, in this embodiment, the inner hole of the nut type rotatable flange collar 1 includes an internal thread section 11, a cutting tool escape section (including a first cutting tool escape section 12 and a second cutting tool escape section 13), and a protuberances fitting section 14, which means that the inner hole of the nut type rotatable flange collar 1 is sequentially divided into at least the above three parts for distinguishing and description. Specifically, the internal thread section 11 is configured to form the connecting thread, and the connecting thread is mainly used for threaded fit with the flange portion 42 of the second neck flange 4, so the internal thread section 11 is configured to fit with the flange portion 42 of the second neck flange 4, and it is preferable that the first neck flange 5 can be easily inserted. The cutting tool escape section is configured to fit with the flange portion of the first neck flange 5 and the hard washer 3 (mainly the first cutting tool escape section 12 fits with the flange portion of the first neck flange 5, and the second cutting tool escape section 13 fits with the hard washer 3), and the cutting tool escape section is further configured to withdraw a cutter during machine tool manufacturing. The protuberances fitting section 14 is configured to form the annular protuberances 16. Similarly, the fitting herein is the same as above, and relative fixed fitting or relative running fit is selected according to different applicable scenes.

The purpose of each part in the inner hole of the nut type rotatable flange collar 1 is expounded. To achieve effective contact and functions of all parts in the inner hole, it is needed that the hard washer 3 can all act on the flange portion of the first neck flange 5, and the flange portion of the first neck flange 5 can all act on the flange portion 42 of the second neck flange 4 (the sealing gasket 6 functions to transmit forces), so as to improve directness and effectiveness of interaction between the jack bolts 2 and the hard washer 3, interaction between the hard washer 3 and the flange portion of the first neck flange 5, and interaction between the flange portion of the first neck flange 5 and the flange portion 42 of the second neck flange 4, and inhibit protrusions on an inner hole surface of the nut type rotatable flange collar 1 from blocking or hindering smoothness of mutual contact between internal parts.

To further ensure contact stability between the screw end of the jack bolts 2 and the hard washer 3, a solid lubricant coating is arranged on an end surface of at least one side of the hard washer 3. That is, the solid lubricant coating is arranged on an end surface of at least one of two sides of the hard washer 3, and functions to inhibit the first neck flange 5 from being driven to rotate when the nut type rotatable flange collar 1 and the second neck flange 4 are relatively fastened, thereby improving lubrication performance and inhibiting the sealing between components from being greatly affected. For a person skilled in the art, it should be clear that the solid lubricant coating mainly refers to a composite material with high strength, high wear resistance and excellent self-lubricating performance that is prepared by adding solid lubricants (graphite, a soft metal, a layered solid, a fluoride, or a polymer), wear-resistant materials (a carbide, a nitride, and a silicide), oxidation-resistant materials (Ni—Mo—Al), and other components into metals (such as Fe-based, Ni-based, and Co-based), ceramics (SiO₂, ZrO₂, and Cr₂O₃) or nonmetallic materials (polytetrafluoroethylene, polyimide, polyether ether ketone, and ultra-high molecular weight polyethylene) as a matrix by using a certain process (hot-dip coating, electroplating, chemical plating or laser cladding), and thus details are not described herein.

Due to the technical solution of adding the solid lubricant coating, the lubricity between the hard washer 3 and the first neck flange 5 and/or between the hard washer 3 and the jack bolts 2 can be increased, thereby inhibiting a case that when there is a large fastening force, synchronous rotation is caused by excessive friction, resulting in the failure to perform further fastening. Certainly, according to different applicable scenes, the solid lubricant coating may be arranged on one side of the hard washer 3 close to the annular protuberances 16, or the solid lubricant coating may be arranged on one side of the hard washer close to the second neck flange 4, or each of two sides of the hard washer 3 maybe arranged with the solid lubricant coating, the purpose of increasing lubrication performance can be achieved no matter which form is used, and wear resistance between components can be improved.

By means of the above technical solution, especially the adding of the solid lubricant coating, when the second neck flange 4 is tightened after the initial pre-fastening of the jack bolts 2, a case that the first neck flange 5 is driven to rotate synchronously due to excessive friction, resulting in the failure to perform further fastening is inhibited, or a case that when the second neck flange 4 is fastened in place and the jack bolts 2 is further tightened, the first neck flange 5 and the second neck flange 4 are driven to rotate synchronously, resulting in the failure to perform further fastening is inhibited. Considering the practical operability, when the preload is large enough and the friction of the solid lubricant coating also relatively becomes large, there is a very small chance that the first neck flange 5 and the second neck flange 4 rotate synchronously, resulting in the failure to perform further fastening. To further improve the limit of the preload, a thread rotation direction of the connecting thread is opposite to a thread rotation direction of the screw through hole 15. In this way, no matter how large the preload is, the synchronous rotation between the first neck flange and the second neck flange due to an external force can be avoided, and sufficient connection stability between the two is ensured.

In addition, since there are tolerance clearances of fit between threads, to eliminate a lack of sealing caused by these clearances when machining accuracy is insufficient, a minimum clearance of fit between the screw through hole 15 and the jack bolts 2 is defined as a first clearance, a minimum clearance of fit between the connecting thread and the external thread of the flange portion 42 of the second neck flange 4 is defined as a second clearance, and the size of the first clearance is greater than the size of the second clearance. That is, when the jack bolts 2 is tightened again, an external force can be applied to the jack bolts 2, and one of the originally same first clearances on two sides of a screw thread of the jack bolts has a size becoming larger, while the other first clearance becomes smaller (on one side in a force application direction). In this case, the second clearance on one side of a screw thread of the connecting thread becomes zero, which ensures that when the external force acts on the jack bolts 2, the external force can fully and effectively act on the second neck flange 4, thereby inhibiting a case that a part of the force causes the first clearance on one side of the jack bolts 2 to become zero in advance, so that the external force cannot be completely transmitted to the second neck flange 4 through the hard washer 3.

Furthermore, the solid lubricant coating can be elastically deformed in an axial direction of the hard washer 3 (the solid lubricant coating can recover after deformation), and the surface of the solid lubricant coating made of the above materials has certain elasticity, can be compressed in the axial direction under the action of the external force, and can recover automatically after the external force disappears. When the solid lubricant coating is arranged on an end surface of one side of the hard washer 3, a maximum deformation quantity of the elastic deformation generated by the solid lubricant coating on the one side is not less than a sum of the sizes of the first clearance and the second clearance; or when each of end surfaces of two sides of the hard washer is arranged with the solid lubricant coating 3, a maximum total deformation quantity of the elastic deformation generated by the solid lubricant coatings on the two sides is not less than the sum of the sizes of the first clearance and the second clearance. With reference to the above technical solution, when the external force is continuously applied to the jack bolts 2 for fastening, the second clearance on one side (one side in the force application direction) of the screw thread of the connecting thread first becomes zero, since the hard washer 3 does not generate enough deformation in this case and thus achieves the function of force transmission, when the second clearance on one side first becomes zero, the jack bolts 2 starts to compress the solid lubricant coating obviously to make the solid lubricant coating reach a maximum deformation quantity, until the first clearance on one side becomes zero, that is, it is impossible to further compress the solid lubricant coating, which means that all the threaded fit is in sealing contact in place and achieves the maximum sealing performance. However, since the seal is formed on the same side of the screw thread, the sealing performance will be reduced once the solid lubricant coating rebounds. During recovering, the solid lubricant coating gradually recovers from a maximum deformation position to an initial position. In this case, since the maximum deformation quantity of the solid lubricant coating is greater than or equal to the sum of the sizes of the first clearance and the second clearance, a sealing form of the same side of the two screw threads can be converted into a sealing form of opposite sides, and the maximum sealing performance is achieved again, thereby ensuring further sealing performance of the entire rotatable flange structure.

By using the above technical solution, a better hermetical connection is formed between the hard washer 3, the flange portion of the first neck flange 5, and the flange portion 42 of the second neck flange 4. To further achieve better sealing performance between the flange portion of the first neck flange 5 and the flange portion 42 of the second neck flange 4, positioning grooves are formed in one side of the flange portion of the first neck flange 5 and one side of the flange portion 42 of the second neck flange 4 that are close to each other, and a volume for accommodating and positioning the sealing gasket 6 is formed between the two positioning grooves. The volume for accommodating and positioning herein matches the configuration of the sealing gasket 6, and is required to be just enough to accommodate the sealing gasket 6, so as to achieve contact sealing. In addition, the sealing gasket 6 is attached to the positioning groove in either side by using a connecting member, and the connecting member may be a bolt, a rivet, a magnet, an adhesive layer, etc., provided that the sealing gasket 6 can be stably connected to either positioning groove, so as to inhibit the sealing gasket 6 from being misaligned to result in unstable sealing when the positioning grooves on the two sides move close to each other for forming.

In addition, the flange portion of the first neck flange 5 and the flange portion 42 of the second neck flange 4 are usually in the form of a rotator. To inhibit stress concentration on a single side, uniform force application is needed to ensure the uniformity of force transmission. A plurality of screw through holes 15 are provided, and the plurality of screw through holes 15 are evenly distributed in the annular protuberances 16 around an axis of the nut type rotatable flange collar 1 in a circumferential direction, in the form shown in FIG. 2. A number of the jack bolts 2 is equal to a number of the screw through holes 15, and each jack bolt 2 fit with threads of each screw through hole 15. In this way, the purpose of comprehensive and balanced force of the entire flange structure during and after assembly can be ensured. In addition, to facilitate the application of the external force and the convenient disassembly and assembly of the entire flange structure, a boss portion 41 that can interact with a wrench is formed on an outer surface of a neck of the second neck flange 4; and/or a boss portion 41 that can interact with a wrench is formed on an outer surface of the nut type rotatable flange collar 1.

By using the above technical solution, it can be concluded that the boss portion 41 that can interact with a wrench is formed on at least one of the outer surface of the neck of the second neck flange 4 and the outer surface of the nut type rotatable flange collar 1. The boss portion 41 herein is mainly a rotary step with an angle, and can cooperate with different open end wrenches, such as a hexagonal open end wrench and a hexagonal boss, which can be secured to each other to facilitate spinning. When the boss portion 41 is formed on the outer surface of the neck of the second neck flange 4, the wrench directly secures the neck of the second neck flange 4, and then a spinning operation is performed, so that mutual fit between the flange portion 42 of the second neck flange 4 and the connecting thread can be achieved, and the nut type rotatable flange collar 1 needs to be secured in this case. The nut type rotatable flange collar 1 maybe secured by another platform or tool. For example, other connecting features or connecting grooves are designed on the nut type rotatable flange collar 1, and the connecting features or the connecting grooves are constrained by a special tool to ensure that the nut type rotatable flange collar 1 does not rotate relatively. For another example, the boss portion 41 is formed on the outer surface of the nut type rotatable flange collar 1, and is also secured by a wrench. This means that the boss portion 41 is provided in the two methods, and any method is available provided that the nut type rotatable flange collar 1 relatively secured.

Similarly, when the boss portion 41 is formed on only the outer surface of the nut type rotatable flange collar 1, the boss portion is secured by the wrench, and then the second neck flange 4 is rotated by another platform or tool. As an alternative to this embodiment, a boss portion 41 is formed on the outer surface of the neck of the second neck flange 4, and the outer surface of the nut type rotatable flange collar 1 can be secured by arranging a boss portion 41 or by another platform or tool.

### Embodiment 2

Referring to FIG. 5, this embodiment further provides a nut type rotatable flange combination tool, including an operating spanner 7 and the nut type rotatable flange structure described in Embodiment 1. It should be noted that the nut type rotatable flange structure in this embodiment is further defined and optimized based on the alternative solution of

Embodiment 1, that is, the nut type rotatable flange structure is provided with a plurality of screw through holes 15, and the plurality of screw through holes 15 are evenly distributed in an annular protuberances 16 around an axis of a nut type rotatable flange collar 1 in a circumferential direction; a number of jack bolts 2 is equal to a number of the screw through holes 15, each jack bolt 2 fit with threads of each screw through holes 15, which is suitable for the form of the plurality of screw through holes 15, and the rest is consistent with the selection range described in Embodiment 1. Moreover, a boss portion 41 is formed on an outer surface of a neck of a second neck flange 4 in this embodiment, and is used for the operating spanner 7 to achieve the purpose of relative fixation. Specifically, the operating spanner 7 includes a handle and a positioning portion 71 connected to each other, and the positioning portion 71 can be fixed to at least two jack bolts 2, that is, the boss portion 41 is formed on the outer surface of the neck of the second neck flange 4, and the nut type rotatable flange collar 1 is secured by another platform or tool. By using the above technical solution, the wrench and the boss portion 41 formed on the outer surface of the neck of the second neck flange 4 are mutually fixed, and are reliably connected, and the positioning portion 71 of the operating spanner 7 and at least two jack bolts 2 of the nut type rotatable flange collar 1 are mutually fixed, so that the second neck flange 4 is independently secured to the nut type rotatable flange collar 1, thereby facilitating a subsequent assembly operation. In addition, this method does not need the machining of other parts or other platforms on the nut type rotatable flange collar 1. For example, the boss portion is formed on the nut type rotatable flange collar 1, which reduces the machining difficulty, and avoids affecting the strength and performance of the nut type rotatable flange collar 1 itself due to a shape change.

In addition, to improve convenience of operation, in this embodiment, the positioning portion 71 is provided with an arc-shaped clamping groove fitting with the outer surface of the neck of the first neck flange 4, and the arc-shaped clamping groove is used for pre-positioning with the neck of the first neck flange 4, but the arc-shaped clamping groove does not need to be in contact with the first neck flange 4, and only provides a function of preliminary positioning. At least two positioning holes are machined in the positioning portion 71, and the at least two positioning holes can be correspondingly sleeved with a same number of jack bolts 2 simultaneously, which means that a number of the positioning holes is the same as a number of the jack bolts 2, and there are at least two positioning holes and at least two jack bolts. Each positioning hole and each jack bolt 2 are sleeved with each other. In this way, the positioning portion 71 can be quickly attached and positioned with the jack bolts 2, thereby facilitating spinning the handle for fastening. The combination tool of this embodiment is relatively more convenient for operation, and is suitable for a case that the outer surface of the nut type rotatable flange collar 1 is a cylindrical surface, so that the nut type rotatable flange collar 1 can be machined and shaped at a lower cost.

The foregoing descriptions are merely preferred embodiments of the present invention and are not intended to limit the present invention, and various modifications and changes of the present invention may be made by a person skilled in the art. Any modifications, equivalent substitutions, improvements, and the like made within the spirit and principle of the present invention should fall within the protection scope of the present invention. It should be noted that the structures or components illustrated in the accompanying drawings are not necessarily drawn to scale, and descriptions of well-known assemblies, processing technologies and processes are omitted in the present invention to avoid unnecessarily limiting the present invention.

What is claimed is:

1. A nut type rotatable flange structure, comprising:
a nut type rotatable flange collar, having a connecting thread on an inner surface from one end of the nut type rotatable flange collar, an annular protuberance formed on an inner surface of an other end of the nut type rotatable flange collar, and a screw through hole disposed in the annular protuberance in an axial direction of the nut type rotatable flange collar;
a first neck flange, having a neck that passes through an inner hole of the annular protuberance, an outer surface of the neck fitting with the inner hole of the annular protuberance, and a flange portion disposed in an inner hole of the nut type rotatable flange collar, an outer surface of the flange portion fitting with the inner hole of the nut type rotatable flange collar;
a second neck flange, having an external thread on an outer surface of a flange portion of the second neck flange, the flange portion fitting with the connecting thread of the nut type rotatable flange collar by the external thread of the flange portion, and a sealing gasket disposed between the flange portion of the second neck flange and the flange portion of the first neck flange; and
a jack bolt, wherein the jack bolt fits with threads of the screw through hole in the annular protuberance, and a screw end of the jack bolt is capable of acting on the flange portion of the first neck flange, so that the flange portion of the first neck flange, the flange portion of the second neck flange, and the sealing gasket are hermetically connected to each other.

2. The nut type rotatable flange structure according to claim 1, further comprising a hard washer, wherein the hard washer is sleeved on the neck of the first neck flange, and the hard washer is abutted against the screw end of the jack bolt and the flange portion of the first neck flange.

3. The nut type rotatable flange structure according to claim 2, wherein the inner hole of the nut type rotatable flange collar comprises an internal thread section, a cutting tool escape section, and a protuberance fitting section that are sequentially connected; and the internal thread section is configured to form the connecting thread, the cutting tool escape section is configured to fit with the flange portion of the first neck flange and the hard washer, a washer fitting section is configured to fit with the hard washer, and the protuberance fitting section is configured to fit the annular protuberance.

4. The nut type rotatable flange structure according to claim 2, wherein a solid lubricant coating is arranged on an end surface of at least one side of the hard washer.

5. The nut type rotatable flange structure according to claim 4, wherein a thread rotation direction of the connecting thread is opposite to a thread rotation direction of the screw through hole, a minimum clearance of fit between the screw through hole and the jack bolt is a first clearance, a minimum clearance of fit between the connecting thread and the external thread of the flange portion of the second neck flange is a second clearance, and the size of the first clearance is greater than the size of the second clearance; and
the solid lubricant coating is capable of generating elastic deformation in an axial direction of the hard washer, and when the solid lubricant coating is arranged on an end surface of one side of the hard washer, a maximum deformation quantity of the elastic deformation generated by the solid lubricant coating on the one side is not less than a sum of the sizes of the first clearance and the second clearance; or when each of end surfaces of two sides of the hard washer is arranged with the solid lubricant coating, a maximum total deformation quantity of the elastic deformation generated by the solid lubricant coatings on the two sides is not less than the sum of the sizes of the first clearance and the second clearance.

6. The nut type rotatable flange structure according to claim 1, wherein positioning grooves are machined in one side of the flange portion of the first neck flange and one side of the flange portion of the second neck flange that are close to each other, respectively, a volume for accommodating and positioning the sealing gasket is formed between the positioning grooves, and the sealing gasket is attached to the positioning groove on either side by a connecting member.

7. The nut type rotatable flange structure according to claim 1, wherein a plurality of screw through holes and a plurality of annular protuberances are provided, and the plurality of screw through holes are evenly distributed in the annular protuberances around the axis of the nut type rotatable flange collar in a circumferential direction; a plurality of jack bolts are provided such that a number of the jack bolts is equal to a number of the screw through holes, and each jack bolt fit with the threads of each screw through hole, respectively.

8. The nut type rotatable flange structure according to claim 1, wherein a boss portion that can interact with a wrench is formed on an outer surface of a neck of the second neck flange; and/or
a boss portion that can interact with a wrench is formed on an outer surface of the nut type rotatable flange collar.

9. A nut type rotatable flange combination tool, comprising an operating spanner and the nut type rotatable flange structure according to claim 1, wherein the nut type rotatable flange structure is provided with a plurality of screw through holes and a plurality of annular protuberances, and the plurality of screw through holes are evenly distributed in the annular protuberances around the axis of the nut type rotatable flange collar in a circumferential direction; a number of jack bolts is equal to a number of the screw through holes, and each jack bolt fits with the threads of each screw through hole, respectively;
wherein the operating spanner comprises a handle and a positioning portion that are connected to each other, and the positioning portion is capable of being fixed by at least two jack bolts; and
wherein a boss portion that can interact with a wrench is formed on an outer surface of a neck of the second neck flange.

10. The nut type rotatable flange combination tool according to claim 9, wherein at least two positioning holes are disposed in the positioning portion, and the at least two positioning holes are capable of being correspondingly sleeved with a same number of jack bolts simultaneously.

11. A nut type rotatable flange combination tool, comprising an operating spanner and the nut type rotatable flange structure according to claim 2, wherein the nut type rotatable flange structure is provided with a plurality of screw through holes and a plurality of annular protuberances, and the plurality of screw through holes are evenly distributed in the annular protuberances around the axis of the nut type rotatable flange collar in a circumferential direction; a number of jack bolts is equal to a number of the screw through holes, and each jack bolt fits with the threads of each screw through hole, respectively;
wherein the operating spanner comprises a handle and a positioning portion that are connected to each other, and the positioning portion is capable of being fixed by at least two jack bolts; and
wherein a boss portion that can interact with a wrench is formed on an outer surface of a neck of the second neck flange.

12. A nut type rotatable flange combination tool, comprising an operating spanner and the nut type rotatable flange structure according to claim 3, wherein the nut type rotatable flange structure is provided with a plurality of screw through holes and a plurality of annular protuberances, and the plurality of screw through holes are evenly distributed in the annular protuberances around the axis of the nut type rotatable flange collar in a circumferential direction; a number of jack bolts is equal to a number of the screw through holes, and each jack bolt fits with the threads of each screw through hole, respectively;
wherein the operating spanner comprises a handle and a positioning portion that are connected to each other, and the positioning portion is capable of being fixed by at least two jack bolts; and
wherein a boss portion that can interact with a wrench is formed on an outer surface of a neck of the second neck flange.

13. A nut type rotatable flange combination tool, comprising an operating spanner and the nut type rotatable flange structure according to claim 4, wherein the nut type rotatable flange structure is provided with a plurality of screw through holes and a plurality of annular protuberances, and the plurality of screw through holes are evenly distributed in the annular protuberances around the axis of the nut type rotatable flange collar in a circumferential direction; a number of jack bolts is equal to a number of the screw through holes, and each jack bolt fits with the threads of each screw through hole, respectively;
wherein the operating spanner comprises a handle and a positioning portion that are connected to each other, and the positioning portion is capable of being fixed by at least two jack bolts; and
wherein a boss portion that can interact with a wrench is formed on an outer surface of a neck of the second neck flange.

14. A nut type rotatable flange combination tool, comprising an operating spanner and the nut type rotatable flange structure according to claim 5, wherein the nut type rotatable flange structure is provided with a plurality of screw through holes and a plurality of annular protuberances, and the plurality of screw through holes are evenly distributed in the annular protuberances around the axis of the nut type rotatable flange collar in a circumferential direction; a number of jack bolts is equal to a number of the screw through holes, and each jack bolt fits with the threads of each screw through hole, respectively;
wherein the operating spanner comprises a handle and a positioning portion that are connected to each other, and the positioning portion is capable of being fixed by at least two jack bolts; and
wherein a boss portion that can interact with a wrench is formed on an outer surface of a neck of the second neck flange.

15. A nut type rotatable flange combination tool, comprising an operating spanner and the nut type rotatable flange structure according to claim 6, wherein the nut type rotatable flange structure is provided with a plurality of screw through holes and a plurality of annular protuberances, and the plurality of screw through holes are evenly distributed in the annular protuberances around the axis of the nut type rotatable flange collar in a circumferential direction; a number of jack bolts is equal to a number of the screw through holes, and each jack bolt fits with the threads of each screw through hole, respectively;
wherein the operating spanner comprises a handle and a positioning portion that are connected to each other, and the positioning portion is capable of being fixed by at least two jack bolts; and
wherein a boss portion that can interact with a wrench is formed on an outer surface of a neck of the second neck flange.

16. The nut type rotatable flange combination tool according to claim 11, wherein at least two positioning holes are disposed in the positioning portion, and the at least two positioning holes are capable of being correspondingly sleeved with a same number of jack bolts simultaneously.

17. The nut type rotatable flange combination tool according to claim 12, wherein at least two positioning holes are disposed in the positioning portion, and the at least two positioning holes are capable of being correspondingly sleeved with a same number of jack bolts simultaneously.

18. The nut type rotatable flange combination tool according to claim 13, wherein at least two positioning holes are disposed in the positioning portion, and the at least two positioning holes are capable of being correspondingly sleeved with a same number of jack bolts simultaneously.

19. The nut type rotatable flange combination tool according to claim 14, wherein at least two positioning holes are disposed in the positioning portion, and the at least two positioning holes are capable of being correspondingly sleeved with a same number of jack bolts simultaneously.

20. The nut type rotatable flange combination tool according to claim 15, wherein at least two positioning holes are disposed in the positioning portion, and the at least two positioning holes are capable of being correspondingly sleeved with a same number of jack bolts simultaneously.
